(19) United States
(12) Patent Application Publication
(10) Pub. No.: US 2024/0381195 A1
(43) Pub. Date: Nov. 14, 2024

(54) INITIAL UPLINK TRANSMISSION IN RACH-LESS HANDOVER

(71) Applicant: Samsung Electronics Co., Ltd., Suwon-si (KR)

(72) Inventors: Shiyang Leng, Allen, TX (US); Anil Agiwal, Allen, TX (US); Kyeongin Jeong, Allen, TX (US)

(21) Appl. No.: 18/646,593

(22) Filed: Apr. 25, 2024

Related U.S. Application Data
(60) Provisional application No. 63/465,154, filed on May 9, 2023.
(60) Provisional application No. 63/530,826, filed on Aug. 4, 2023.

(51) Int. Cl. H04W 36/00; H04B 17/318; H04W 56/00; H04W 72/1273; H04W 72/231; H04W 76/28; H04W 84/06

(52) U.S. Cl. CPC H04W 36/00725; H04B 17/328; H04W 56/0045; H04W 72/1273; H04W 72/231; H04W 76/28; H04W 84/06

(57) ABSTRACT

Methods and apparatuses for a MAC CE for multi-TRP operation in a wireless communication system. A method of a UE comprises: receiving, from a base station, a RACH-less switching command for a RACH-less switching operation to a target cell; determining whether a DRX is configured for the target cell; and retaining an active time during the RACH-less switching operation based on a determination that the DRX is configured for the target cell, monitoring a PDCCH to acquire a UL grant of an initial UL transmission, wherein the initial UL transmission for the RACH-less switching operation includes a transmission of a RRCReconfigurationComplete message to a target satellite or the target cell.

### CROSS-REFERENCE TO RELATED APPLICATIONS AND CLAIM OF PRIORITY

The present application claims priority to U.S. Provisional Patent Application No. 63/465,154, filed on May 9, 2023, and U.S. Provisional Patent Application No. 63/530,826, filed on Aug. 4, 2023. The contents of the above-identified patent documents are incorporated herein by reference.

### TECHNICAL FIELD

The present disclosure relates generally to wireless communication systems and, more specifically, the present disclosure relates to an initial uplink transmission in random access channel (RACH)-less handover in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to an initial uplink transmission in RACH-less handover in a wireless communication system.

In one embodiment, a user equipment (UE) in a wireless communication system is provided. The UE comprises: a transceiver configured to receive, from a base station, a random access channel-less (RACH-less) switching command for a RACH-less switching operation to a target cell. The UE further comprises a processor operably coupled to the transceiver, the processor configured to: determine whether a discontinuous reception (DRX) is configured for the target cell, retain an active time during the RACH-less switching operation based on a determination that the DRX is configured for the target cell, and monitor a physical downlink control channel (PDCCH) to acquire an uplink (UL) grant of an initial UL transmission, wherein the initial UL transmission for the RACH-less switching operation includes a transmission of a RRCReconfigurationComplete message to a target satellite or the target cell.

In another embodiment, a method of a UE in a wireless communication system is provided. The method comprises: receiving, from a base station, a RACH-less switching command for a RACH-less switching operation to a target cell; determining whether a DRX is configured for the target cell; retaining an active time during the RACH-less switching operation based on a determination that the DRX is configured for the target cell, and monitoring, a PDCCH to acquire a UL grant of an initial UL transmission, wherein the initial UL transmission for the RACH-less switching operation includes a transmission of a RRCReconfigurationComplete message to a target satellite or the target cell.

In yet another embodiment, a BS in a wireless communication system is provided. The BS comprises a processor configured to generate a RACH-less switching command and generate a DRX configuration. The BS further comprises a transceiver operably coupled to the processor, the transceiver configured to transmit, to a UE, the RACH-less switching command for a RACH-less switching operation to a target cell, transmit, to the UE, the DRX configuration, and transmit, to the UE, a physical downlink control channel (PDCCH), wherein: whether the DRX is configured for the target cell is determined, an active time is retained during the RACH-less switching operation based on a determination that the DRX is configured for the target cell, the PDCCH is monitored to acquire a UL grant of an initial UL transmission, and the initial UL transmission for the RACH-less switching operation includes a transmission of a RRCReconfigurationComplete message to a target satellite or the target cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIGS. 6 and 7 illustrate examples of RACH-less initial UL transmission with CG occasions associated to SSBs according to embodiments of the present disclosure; and

FIG. 8 illustrates a flowchart of a UE method for an initial uplink transmission in RACH-less handover according to embodiments of the present disclosure.

### DETAILED DESCRIPTION

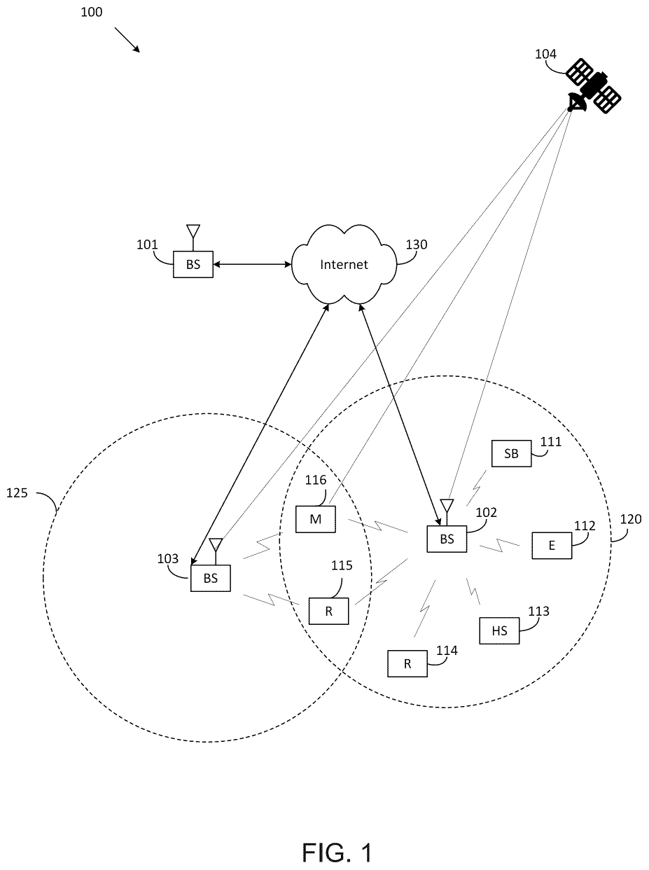

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: “3GPP, TS 38.300 v17.3.0, 5G; NR; NR and NG-RAN Overall Description; Stage 2”; “3GPP, TS 38.331 v17.3.0, 5G; NR; Radio Resource Control (RRC); Protocol specification”; and “3GPP, TS 38.321 v17.3.0, NR; Medium Access Control (MAC) protocol specification”; “3GPP, TS 38.214 v17.3.0, NR; Physical layer procedures for data”; “3GPP, TR 38.811 v15.2.0, Study on NR to support non-terrestrial networks”; and “3GPP, TR 38.821 v16.0.0, Solutions for NR to support non-terrestrial networks (NTN).”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

An NTN refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof, for performing an initial uplink transmission in RACH-less handover in a wireless communication system. In certain embodiments, and one or more of the gNBs 101-103 includes circuitry, programing, or a combination thereof, for supporting an initial uplink transmission in RACH-less handover in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

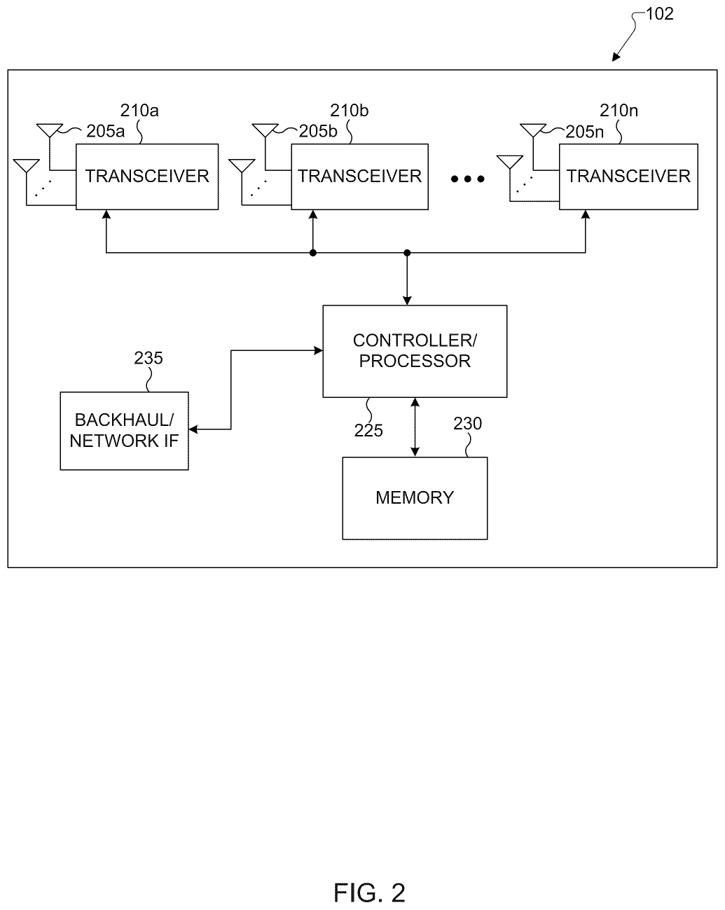

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes for supporting an initial uplink transmission in RACH-less handover in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

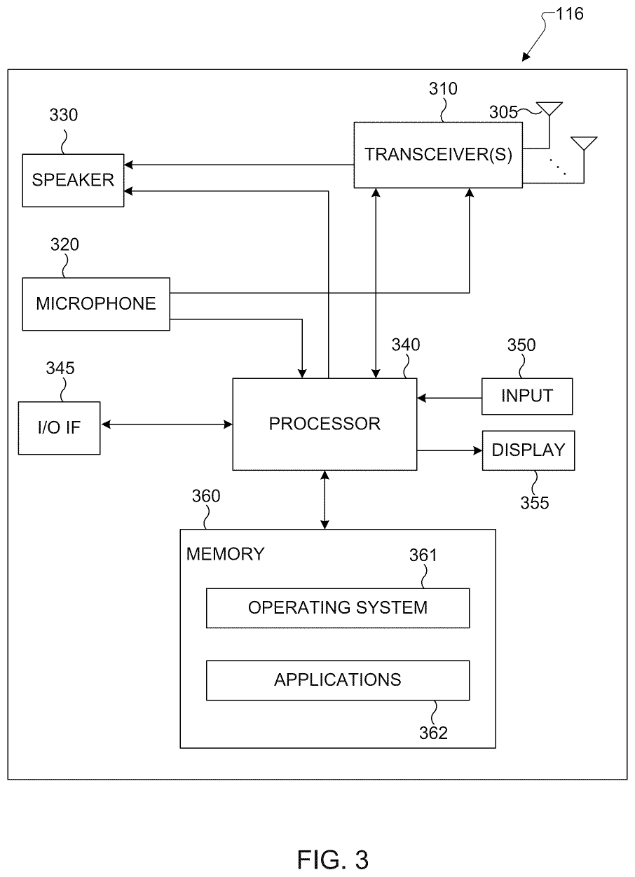

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for an initial uplink transmission in RACH-less handover in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

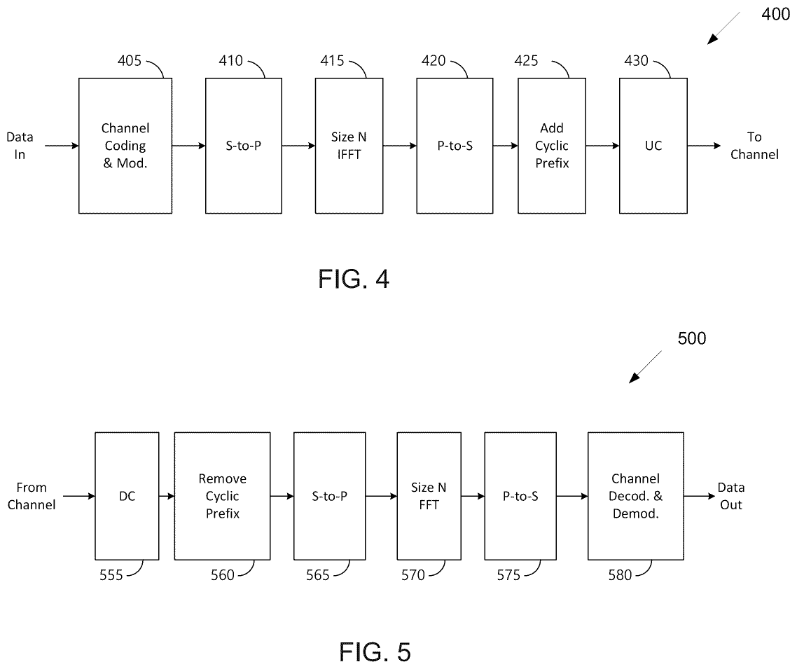

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the transmit path 400 is configured to perform an initial uplink transmission in RACH-less handover in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UE 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

3GPP has developed technical specifications and standards to define the new 5G radio-access technology, known as 5G new radio (NR). In Release 17 specification, the non-terrestrial network (NTN) is supported as a vertical functionality by 5G NR. A non-terrestrial network (NTN) providing non-terrestrial NR access to a UE by means of an NTN payload, e.g., a satellite, and an NTN Gateway. The NTN payload transparently forwards the radio protocol received from the UE (via the service link, i.e., wireless link between the NTN payload and the UE) to the NTN Gateway (via the feeder link, i.e., wireless link between the NTN Gateway and the NTN payload) and vice-versa. Considering its capabilities of providing wide coverage and reliable service, NTN is envisioned to ensure service availability and continuity ubiquitously.

For instance, NTN can support communication services in unserved areas that cannot be covered by conventional terrestrial networks, in underserved areas that are experiencing limited communication services, for devices and passengers on board moving platforms, and for future railway/maritime/aeronautical communications. To support NTN in 5G NR, various features need to be introduced or enhanced to accommodate the nature of radio access to NTN that is different to terrestrial networks (TN) such as large cell coverage, long propagation delay, and non-static cell/satellite.

In NTN, the NTN payload can be GSO, i.e., earth-centered orbit at approximately 35786 kilometers above Earth's surface and synchronized with Earth's rotation, or NGSO, i.e., low Earth orbit (LEO) at altitude approximately between 300 km and 1500 km and medium Earth orbit (MEO) at altitude approximately between 7000 km and 25000 km. Depending on different NTN payloads, three types of service links are supported: (1) Earth-fixed: provisioned by beam(s) continuously covering the same geographical areas all the time (e.g., the case of GSO satellites); (2) quasi-Earth-fixed: provisioned by beam(s) covering one geographic area for a limited period and a different geographic area during another period (e.g., the case of NGSO satellites generating steerable beams); and (3) Earth-moving: provisioned by beam(s) whose coverage area slides over the Earth surface (e.g., the case of NGSO satellites generating fixed or non-steerable beams).

With NGSO satellites, a BS can provide either quasi-Earth-fixed cell coverage or Earth-moving cell coverage, while BS operating with GSO satellite can provide Earth fixed cell coverage. Due to different properties of GSO and NGSO, different types of cells can be supported in NTN, which are the earth-fixed cell, the quasi-earth-fixed cell, and the earth-moving cell. For a certain type of NTN payload/cell, specific features or functionalities are desired to be supported by the UE for radio access.

For a UE in a connected state (e.g., RRC_CONNECTED), the NW can provide measurement configuration for a measurement object (e.g., intra-frequency or inter-frequency neighbor cells). Based on the measurement results of a UE, the BS can prepare a handover (HO) from the current serving cell, i.e., source cell, to a target cell and trigger the HO execution by transmitting a HO command in an RRC message (e.g., RRCReconfiguration). The BS can also prepare a conditional HO (CHO) with multiple candidate cells for the UE and transmits CHO configuration in an RRC message (e.g., RRCReconfiguration) to trigger the CHO evaluation.

Due to the large propagation distance between a UE and a gNB in NTN, HO delay and interruption caused by message exchanges between the UE and the gNB can be large. On the other hand, due to the large size of NTN cell, a large number of UEs may need to perform HO almost at the same time for quasi-fixed cell. In order to reduce the HO delay and HO overhead, RACH-less HO, i.e., HO without RACH, is desired.

Similarly, for TN, RACH-less HO can also be applied to reduce the HO delay and HO overhead. In the present disclosure, RACH-less HO can refer to a handover operation without performing random access to the target cell in TN and/or NTN, and it can also refer to a L1/L2-triggered cell switch over operation without performing random access to the target cell.

In RACH-less HO, a UE performs DL and UL synchronization autonomously based on configurations in the RACH-less HO command. Then, the UE sends an initial UL transmission to notify its arrival in the target cell and NW confirms UE's arrival by sending a confirmation, in such a way the RACH-less HO is declared to be successfully completed. Thus, UE behavior regarding the initial UL transmission, e.g., UL carrier selection, BWP selection, HARQ procedure, DRX, etc. may be specified.

The present disclosure includes embodiments specifying UE behaviors (e.g., UL carrier selection, BWP selection, HARQ procedure, DRX, etc.) when sending the initial UL transmission in RACH-less HO.

Upon receiving a HO command (e.g., RRCReconfiguration message, a MAC CE), if RACH-less HO configuration or an indication of RACH-less cell switch is included in the HO command, the UE performs RACH-less HO to the target cell indicated in the HO command. The UE performs DL and UL synchronization autonomously based on configurations in the RACH-less HO command. Then, the UE sends an initial UL transmission to notify its arrival in the target cell and NW confirms UE's arrival by sending a confirmation, in such a way the RACH-less HO is declared to be successfully completed.

In one embodiment, the assistance information of the serving/neighbor/source/target cell/satellite (e.g., ephemeris, common TA parameters, ntn-Config) can be configured mapping to one or more SSB indices configured for the serving/neighbor/source/target cell, and/or configured mapping to one or more preamble indices, and/or RACH resource/configuration, and/or RACH-less HO configuration (e.g., including RRC configured pre-allocated UL grant or dynamic grant in PDCCH).

In one example, when RACH is initiated by a UE or by a PDCCH order, if a SSB and/or a preamble index and/or a RACH resource/configuration is selected for PRACH transmission, if the SSB and/or the preamble index and/or the RACH resource/configuration is associated with the assistance information of the serving/neighbor/source/target cell/satellite, the assistance information of the serving/neighbor/source/target cell/satellite is used for UL synchronization (e.g., TA and/or frequency (Doppler shift) pre-compensation) in PRACH transmission.

For another instance, when RACH-less HO is initiated, if a SSB and/or a RACH-less HO configuration and/or a RRC configured pre-allocated UL grant and/or a dynamic grant in PDCCH is selected or indicated in the RACH-less HO command for initial UL transmission, and if the SSB and/or the RACH-less HO configuration and/or the RRC configured pre-allocated UL grant and/or the dynamic grant in PDCCH is associated with the assistance information of the serving/neighbor/source/target cell/satellite, the assistance information of the serving/neighbor/source/target cell/satellite is used for UL synchronization (e.g., TA and/or frequency (Doppler shift) pre-compensation) in initial UL transmission in RACH-less HO.

In one embodiment, the RACH-less HO configuration is included in the RACH-less HO command, which can include the pre-allocated UL grant (e.g., type-1 CG) for the initial UL transmission. The NW can configure a normal UL carrier and/or a supplementary UL carrier for the UE (e.g., in servingCellConfig for the target cell). If the pre-allocated UL grant is configured for the normal UL carrier or if the normal UL carrier is indicated to be used for initial UL transmission, the UE selects the signaled normal UL carrier to send the initial UL transmission; else if the pre-allocated UL grant is configured for supplementary UL carrier is configured or if the supplementary UL carrier is indicated to be used for initial UL transmission, the UE selects the signaled supplementary UL carrier to send the initial UL transmission.

In another embodiment, the RACH-less HO configuration is included in the RACH-less HO command. If the pre-allocated UL grant (e.g., type-1 CG) for the initial UL transmission is not included, the UE monitors target cell PDCCH that provides dynamic UL grant for the initial UL transmission. If a supplementary UL carrier is configured in additional to the normal UL carrier (e.g., in servingCellConfig for the target cell), the DCI format 0_0 or format 0_1 in the PDCCH can include a one-bit field to indicate whether the normal UL carrier or the supplementary UL carrier is used for the initial UL transmission, and the UE follows the indication to send the initial UL transmission on the indicated UL carrier.

In one embodiment, if the indication/configuration of whether the normal UL carrier or the supplementary UL carrier is used for initial UL transmission is not explicitly signaling in RRC RACH-less HO configuration or in DCI format 0_0/0_1, and if a RSRP threshold (e.g., rsrp-ThresholdSSB-SUL) is configured for the UL carrier selection, and if the RSRP of the downlink pathloss reference is less than the configured RSRP threshold (e.g., rsrp-ThresholdSSB-SUL), the UE can select the supplementary UL (SUL) carrier and/or set the PCMAX to PCMAX,f,c of the SUL carrier; if the RSRP of the downlink pathloss reference is not less than the configured RSRP threshold (e.g., rsrp-ThresholdSSB-SUL), the UE can select the normal UL carrier and set the PCMAX to PCMAX,f,c of the NUL carrier.

In one embodiment, after the UL carrier selection, the UE performs bandwidth part (BWP) operation for the initial UL transmission for RACH-less HO. In one example, the UE performs RACH-less HO and sends the initial UL transmission on the first active UL BWP which is configured by firstActiveUplinkBWP-Id included in the uplink configuration uplinkConfig in the servingCellConfig for the target cell. If firstActiveUplinkBWP is not signaled, the UE switches the active UL BWP to BWP indicated by initialUplinkBWP and performs initial UL transmission on the active UL BWP.

In another example, the BWP for the initial UL transmission using the pre-allocated UL grant (e.g., type-1 CG) and/or the dynamic grant can be configured in the RACH-less HO configuration by indicating the BWP-ID. In another example, for the pre-allocated UL grant, a configured grant ID (e.g., configuredGrantConfigIndex, configuredGrantConfigIndexMAC) can be included in the RACH-less HO configuration that refers to the configured grant be used as the pre-allocated UL grant for initial UL transmission, and the BWP for which the corresponding configured grant is configured is selected for the initial UL transmission.

In one embodiment, a beam indication can be included in the RACH-less HO command which can be a RRC message or MAC CE or L1 signaling. The beam indication can be the identifiers for one or more TCI states. In one example, a joint TCI state is indicated if the type of TCI state is configured as “joint.”

In another example, one DL TCI state and one UL TCI state can be indicated if the type of TCI state is configured as “separate.” The beam indication, e.g., joint TCI state or DL TCI state, can indicate the beam to be used to monitor the PDCCH providing the dynamic grant for the initial UL transmission for RACH-less HO. The beam indication, e.g., joint TCI state or UL TCI state, can indicate the beam to be used for the initial UL transmission for RACH-less HO, where the initial UL transmission can use either the configured grant if configured or the dynamic grant provided in PDDCH.

In one embodiment, if configured grant (CG) is provided for the first UL transmission to the target cell in RACH-less HO, multiple CG configurations can be provided, and each CG configuration defines the resource in time and frequency for the first UL transmission. Each CG configuration can also include the spatial information associated to the resource. In one example, the association to reference signals (RS) can be indicated in each CG configuration in a way that one or multiple reference signals (RS) are associated to a CG occasion and the RS can be SSB or CSI-RS. If the association to SSBs is configured in a CG configuration, SSB indexes and the number of SSBs per CG occasion can be configured in a CG configuration.

If a beam indication (e.g., one or more TCI states) is provided in the RACH-less HO command, the UE selects the RS corresponding to the beam indication and selects the CG occasion configured in the CG configuration(s) that corresponding to the selected RS; the UE select a transmission beam corresponding to the beam indication (e.g., joint or UL TCI state). The transmission beam can be quasi-colocated with the RS corresponding to the beam indication. The UE then uses the selected CG occasion and the selected transmission beam to transmit the first UL transmission (e.g., including RRCReconfigurationComplete message). The NW (e.g., target cell) may monitor CG occasions corresponding to the beam indication to receive the initial UL transmission, and a reception beam quasi-colocated to the RS corresponding to the beam indication can be used by the NW for receiving the initial UL transmission.

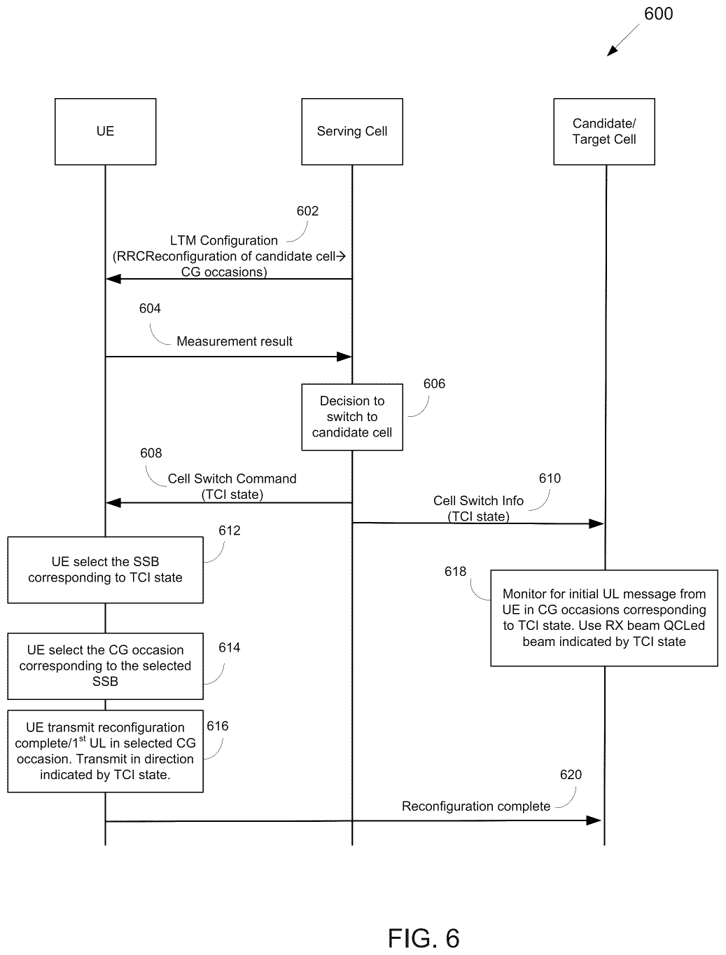

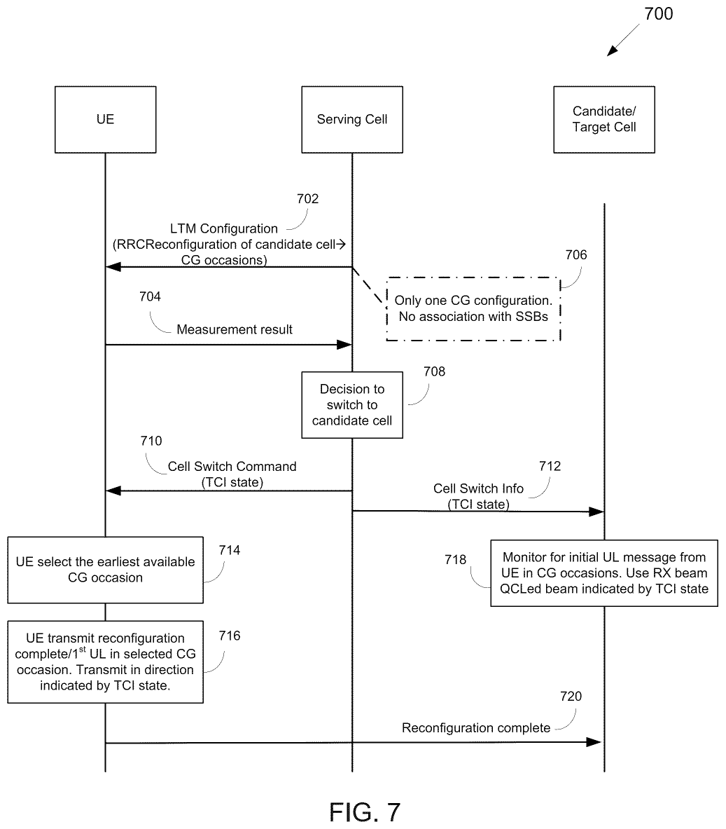

FIGS. 6 and 7 illustrate examples of RACH-less initial UL transmission with CG occasions associated to SSBs 600 and 700 according to embodiments of the present disclosure. Embodiments of the RACH-less initial UL transmission with CG occasions associated to SSBs 600 and 700 shown in FIGS. 6 and 7 are for illustration only.

As illustrated in FIG. 6, a serving cell sends an LTM configuration to a UE. In step 602. In step 604, the UE sends a measurement result to the service cell. In step 606, the service cell determines whether to switch to a candidate cell. In step 608, the service cell sends a cell switch command to the UE. In step 610, the service cell sends cell switch information to the candidate/target cell. In step 612, the UE selects the SSB corresponding to TCI state. In step 614, the UE selects the CH corresponding to the selected SSB in step 612. In step 616, the UE generate reconfiguration complete to the serving cell. In step 618, the candidate cell monitors for an initial message from the UE. In step 620, the UE sends a reconfiguration complete to the candidate cell.

As illustrated in FIG. 7, in step 702, a serving cell sends an LTM configuration to a UE. In step 704, the UE sends a measurement result to the serving cell. In step 706, the service cell includes only one CG configuration. In step 708, the serving cell determines whether to switch to a candidate cell. In step 710, the service cell sends a cell switch command. In step 712, the serving cell sends cell switch information. In step 714, the UE selects the earliest available CG occasion. In step 718, the candidate target cell monitors for initial UL message from the UE. In step 716, the UE generates a reconfiguration complete. In step 720, the UE transmits the reconfiguration complete to the candidate/target cell.

In one embodiment, if configured grant (CG) is provided for the first UL transmission to the target cell in RACH-less HO, a single CG configuration can be provided, that defines the resource for the first UL transmission in time and frequency domain. If beam indication (e.g., one or more TCI states) is provided in the RACH-less HO command, the UE selects the RS corresponding to the beam indication and selects a transmission beam corresponding to the beam indication (e.g., joint or UL TCI state). The transmission beam can be quasi-colocated with the RS corresponding to the beam indication. The UE then uses the earliest CG occasion configured in the CG configuration and the selected transmission beam to transmit the first UL transmission (e.g., including RRCReconfigurationComplete message). The NW (e.g., target cell) may monitor CG occasions configured in the CG configuration and use a reception beam quasi-colocated to the RS corresponding to the beam indication to receive the initial UL transmission.

In one embodiment, in the initial UL transmission, either using the RRC configured pre-allocated UL grant (e.g., type-1 CG) or the dynamic grant in PDCCH, the MAC entity can include the RRC message RRCReconfigurationComplete, and/or C-RNTI MAC CE and/or TA report MAC CE and/or Buffer Status Report, and/or UL data. The logical channel prioritization can be specified in accordance with the following order (highest priority listed first): for example, C-RNTI MAC CE, the RRC message RRCReconfigurationComplete, TA report MAC CE, other MAC CEs, other UL data from any Logical Channel; for another example, C-RNTI MAC CE, TA report MAC CE, the RRC message RRCReconfigurationComplete, other MAC CEs, other UL data from any Logical Channel; for one more example, C-RNTI MAC CE, the RRC message RRCReconfigurationComplete, TA report MAC CE, other MAC CEs, other UL data from any Logical Channel.

For NTN, a TA report MAC CE can be included in the initial UL transmission in RACH-less HO. In one example, a TA report MAC CE is included in the initial UL transmission in RACH-less HO if there is enough UL grant. In another example, if ta-Report is enabled in RACH-less HO configuration, a TA report is triggered, and a TA report MAC CE is included in the initial UL transmission if there is enough UL grant; if ta-Report is not configured in RACH-less HO configuration, the TA report MAC CE may not be included in the initial UL transmission. As one more example, if ta-Report is enabled in RACH-less HO configuration, a TA report MAC CE is included in the initial UL transmission if there is enough UL grant; if ta-Report is not configured in RACH-less HO configuration and TA report event is triggered based on the configured offsetThresholdTA, a TA report MAC CE is included in the initial UL transmission if there is enough UL grant.

In another example, if ta-Report is enabled in RACH-less HO configuration and if TA report event is triggered based on the configured offsetThresholdTA, a TA report MAC CE is included in the initial UL transmission if there is enough UL grant; otherwise, the TA report MAC CE may not be included in the initial UL transmission. For one more example, if ta-Report is enabled in RACH-less HO configuration, TA report MAC CE is triggered after successful completion of RACH-less handover. For one another example, TA report MAC CE is triggered after successful completion of RACH-less handover.

In one embodiment for the HARQ process of the initial UL transmission of RACH-less HO, the HARQ process ID 0 can be used. In another example, the HARQ process ID for the initial UL transmission using pre-allocated UL grant and/or using dynamic grant in PDCCH can be configured in RACH-less HO configuration. Or the HARQ process ID for the initial UL transmission using dynamic grant in PDCCH is indicated in the DCI format 0_0/0_1. As another example, the HARQ process ID for the initial UL transmission can be determined by the UE using the first symbol of the transmission based on the configuration of the pre-allocated UL grant (e.g., type-1 CG). For example, if the pre-allocated UL grant (e.g., type-1 CG) is neither configured with harq-ProcID-Offset2 nor with cg-RetransmissionTimer, the HARQ Process ID associated with the initial UL transmission is derived from the following equation: HARQ Process ID=[floor (CURRENT_symbol/periodicity)] modulo nrofHARQ-Processes; if the pre-allocated UL grant (e.g., type-1 CG) is configured with harq-ProcID-Offset2, the HARQ Process ID associated with the initial UL transmission is derived from the following equation: HARQ Process ID=[floor (CURRENT_symbol/periodicity)] modulo nrofHARQ-Processes+harq-ProcID-Offset2, where CURRENT_symbol=(SFN×numberOfSlotsPerFrame×numberOfSymbolsPerSlot+slot number in the frame×numberOfSymbolsPerSlot+symbol number in the slot), and numberOfSlotsPerFrame and numberOfSymbolsPerSlot refer to the number of consecutive slots per frame and the number of consecutive symbols per slot, respectively as specified in TS 38.211.

For one embodiment, if the pre-allocated UL grant (e.g., type-1 CG) is configured by RRC, the UE can send the initial UL transmission in one HARQ process, which can include the RRC message RRCReconfigurationComplete, and/or C-RNTI MAC CE and/or TA report MAC CE and/or Buffer Status Report, and/or UL data.

In another embodiment, before the successful completion of the RACH-less HO, the MAC entity may not select the logical channel(s) corresponding to DRB(s) for the uplink grant for the HARQ process of initial UL transmission. For example, the UE can only include the RRC message RRCReconfigurationComplete and/or C-RNTI MAC CE in the initial UL transmission and include other specified MAC CEs (e.g., TA report MAC CE if configured to report TA) if the UL grant for the initial UL transmission is enough, and the DRBs for the target cell are suspended before receiving the NW confirmation of RACH-less HO completion, such that MAC CEs and/or UL data that cannot be contained in the initial UL transmission are only allowed to be transmitted after the RACH-less HO completion.

If multiple HARQ processes are configured for the pre-allocated UL grant (e.g., type-1 CG), before receiving the NW confirmation of RACH-less HO completion, the UE can also send UL transmissions in other one or more parallel HARQ processes besides the HARQ process of the initial UL transmission to include the RRC message(s)/MAC CE(s)/data not included in the HARQ process of the initial UL transmission. Before the successful completion of the RACH-less HO, the MAC entity can send data on the logical channel(s) corresponding to DRB(s) for the uplink grant for the other HARQ process(es) than the HARQ process for the initial UL transmission.

In another example, the UE is not allowed to send UL transmission in other HARQ processes except the initial UL transmission and the corresponding HARQ process before receiving the NW confirmation of RACH-less HO completion. Before the successful completion of the RACH-less HO, the MAC entity is not allowed send data on the logical channel(s) corresponding to DRB(s) for the uplink grant for the other HARQ process(es) than the HARQ process for the initial UL transmission.

In one embodiment, DRX operation can be applied to the initial UL transmission in RACH-less HO. For HARQ process of the initial UL transmission, HARQ mode A or HARQ mode B can be configured. In one example, the HARQ mode for the initial UL transmission is configured in RACH-less HO configuration. If the initial UL transmission is transmitted in the pre-allocated UL grant (e.g., type-1 CG) and LBT failure indication is not received from lower layers, the MAC entity may perform operations as shown in TABLE 1.

TABLE 1
Operations for the MAC entity

```
1> if uplinkHARQ-Mode is configured:
  2> if the corresponding HARQ process is configured as HARQModeA:
    3> set HARQ-RTT-TimerUL-NTN for the corresponding HARQ process equal to
      drx-HARQ-RTT-TimerUL plus the latest available UE-gNB RTT value;
    3> if drx-LastTransmissionUL is configured:
      4> start the HARQ-RTT-TimerUL-NTN for the corresponding HARQ process
        in the first symbol after the end of the last transmission (within a bundle) of
        the corresponding PUSCH transmission.
    3> else:
      4> start the HARQ-RTT-TimerUL-NTN for the corresponding HARQ process
        in the first symbol after the end of the first transmission (within a bundle) of
        the corresponding PUSCH transmission.
1> else:
  2> if drx-LastTransmissionUL is configured:
    3> start the drx-HARQ-RTT-TimerUL for the corresponding HARQ process in the
      first symbol after the end of the last transmission (within a bundle) of the
      corresponding PUSCH transmission.
  2> else:
    3> start the drx-HARQ-RTT-TimerUL for the corresponding HARQ process in the
      first symbol after the end of the first transmission (within a bundle) of the
      corresponding PUSCH transmission.
1> stop the drx-RetransmissionTimerUL for the corresponding HARQ process at the first
  transmission (within a bundle) of the corresponding PUSCH transmission.
```

In one embodiment, when DRX is configured for the cell group of the serving/target cell, the active time can include the time while a UE is monitoring PDCCH for dynamic grant for the initial UL transmission during RACH-less HO procedure (i.e., since the start of timer T304 supervising the RACH-less HO procedure). In another example, when DRX is configured for the cell group of the serving/target cell, the active time can include the time while RACH-less HO is on-going (i.e., timer T304 is running for the RACH-less HO). If the PDCCH indicates a dynamic grant for the initial UL transmission, the MAC entity may perform operations as shown in TABLE 2.

TABLE 2
Operations for MAC entity

```
1> if uplinkHARQ-Mode is configured:
  2> if the corresponding HARQ process is configured as HARQModeA:
    3> set HARQ-RTT-TimerUL-NTN for the corresponding HARQ process equal to
      drx-HARQ-RTT-TimerUL plus the latest available UE-gNB RTT value;
    3> if drx-LastTransmissionUL is configured:
      4> start the HARQ-RTT-TimerUL-NTN for the corresponding HARQ process
        in the first symbol after the end of the last transmission (within a bundle) of
        the corresponding PUSCH transmission.
    3> else:
      4> start the HARQ-RTT-TimerUL-NTN for the corresponding HARQ process
        in the first symbol after the end of the first transmission (within a bundle) of
        the corresponding PUSCH transmission.
1> else:
  2> if drx-LastTransmissionUL is configured:
    3> start the drx-HARQ-RTT-TimerUL for the corresponding HARQ process in the
      first symbol after the end of the last transmission (within a bundle) of the
      corresponding PUSCH transmission.
  2> else:
    3> start the drx-HARQ-RTT-TimerUL for the corresponding HARQ process in the
      first symbol after the end of the first transmission (within a bundle) of the
      corresponding PUSCH transmission.
1> stop the drx-RetransmissionTimerUL for the corresponding HARQ process.
```

In one embodiment, once the RACH-less HO is completed, the RACH-less HO configuration is released, which includes the pre-allocated UL grant (e.g., type-1 CG) if configured in the RACH-less HO configuration. Alternatively, the NW can configure (e.g., by an explicit one-bit indication in RRC or by implicit indication) whether the pre-allocated UL grant (e.g., type-1 CG) if configured in the RACH-less HO configuration is released or not after the RACH-less HO completion. For another example, if the pre-allocated UL grant (e.g., type-1 CG) for the initial UL transmission of the RACH-less HO is explicitly configuration as a configured grant (e.g., by IE configuredGrantConfig) in the RACH-less HO configuration, the UE releases the pre-allocated UL grant after RACH-less HO completion; if the pre-allocated UL grant (e.g., type-1 CG) for the initial UL transmission of the RACH-less HO is configured in the RACH-less HO configuration by indicating the configured grant configuration index in a UL BWP (e.g., configuredGrantConfigIndex) or the configured grant configuration index in the MAC entity (e.g., configuredGrantConfigIndexMAC) and the corresponding configured grant configuration is included in the BWP-UplinkDedicated in the UplinkConfig of servingCellConfig, the UE can maintain this pre-allocated UL grant after RACH-less HO completion.

In one example, the pre-allocated UL grant (e.g., type-1 CG) if configured in the RACH-less HO configuration can be maintained and applied for UL transmissions after RACH-less HO completion.

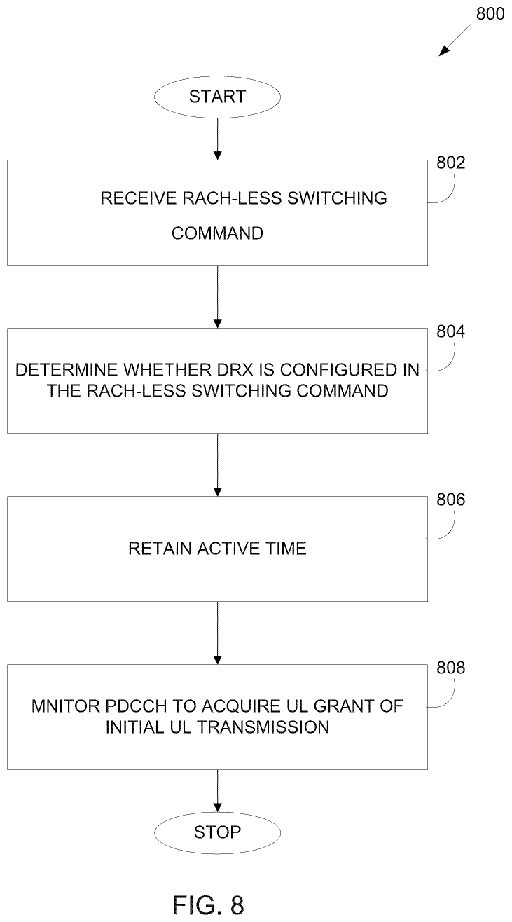

FIG. 8 illustrates a flowchart of a UE method 800 for an initial uplink transmission in RACH-less handover in a wireless communication system. The method 800 as may be performed by a UE (e.g., 111-116 as illustrated in FIG. 1). An embodiment of the method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, the method 800 begins at step 802. In step 802, a UE receives, from a base station, a RACH-less switching command for a RACH-less switching operation to a target cell.

In step 804, the UE determines whether a DRX is configured for the target cell.

In step 806, the UE retains an active time during the RACH-less switching operation based on a determination that the DRX is configured for the target cell.

In step 808, the UE monitors a PDCCH to acquire a UL grant of an initial UL transmission, wherein the initial UL transmission for the RACH-less switching operation includes a transmission of a RRCReconfigurationComplete message to a target satellite or the target cell.

In one embodiment, the UE receives mapping information between a list of satellite assistance information and a list of configurations for the RACH-less switching operation; selects, based on the RACH-less switching command, a configuration from the list of the configurations, including a RACH-less UL grant and a UL carrier; determines, based on the mapping information, satellite assistance information mapped to the RACH-less UL grant; determines a UL TA and a frequency shift based on the satellite assistance information; compensates the UL TA and the frequency shift to perform the initial UL transmission for the RACH-less switching operation; and performs the initial UL transmission based on the RACH-less UL grant corresponding to the UL carrier.

In such embodiment, the satellite assistance information includes at least one of satellite ephemeris or TA information; the RACH-less switching operation includes a handover operation, a satellite switching operation, or a cell switching operation; and the configuration further includes beam information comprising a TCI state and an SSB index.

In one embodiment, the UE receives mapping information between a list of satellite assistance information and a list of RACH resources including at least one of a set of SSB indexes or a set of preamble indexes for a PRACH preamble; selects a RACH resource based on the list of RACH resources; determines, based on the mapping information, the satellite assistance information mapped to the RACH resource; determines, based on the satellite assistance information, the UL TA and a frequency shift; and compensates the UL TA and the frequency shift to transmit the PRACH preamble; and transmits the PRACH preamble based on the RACH resource.

In one embodiment, the UE receives, from the base station, an indication associated with the RACH-less UL grant for the RACH-less switching operation based on a type of the UL carrier, wherein the type of the UL carrier comprises a normal UL carrier or a supplemental UL carrier, and wherein the type of the UL carrier is indicated via DCI or included in configuration information for the RACH-less switching operation.

In one embodiment, the UE measures an RSRP of a DL pathloss reference signal; and selects the supplemental UL carrier when a measurement result of the RSRP of the DL pathloss reference signal is less than an RSRP threshold or select the normal UL carrier when the measurement result of the RSRP of the DL pathloss reference signal is greater than the RSRP threshold, wherein the indication comprises the RSRP threshold for configuring the RACH-less UL grant.

In one embodiment, the UE receives the RACH-less UL grant configured on the normal UL carrier or the supplemental UL carrier.

In one embodiment, the UE release the RACH-less UL grant when the RACH-less UL grant for the initial UL transmission of the RACH-less switching operation is included in the RACH-less switching command after the RACH-less switching operation is completed.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive, from a base station, a random access channel-less (RACH-less) switching command for a RACH-less switching operation to a target cell; and
a processor operably coupled to the transceiver, the processor configured to:
determine whether a discontinuous reception (DRX) is configured for the target cell,
retain an active time during the RACH-less switching operation based on a determination that the DRX is configured for the target cell, and
monitor a physical downlink control channel (PDCCH) to acquire an uplink (UL) grant of an initial UL transmission,
wherein the initial UL transmission for the RACH-less switching operation includes a transmission of a RRCReconfigurationComplete message to a target satellite or the target cell.

2. The UE of claim 1, wherein:
the transceiver is further configured to receive mapping information between a list of satellite assistance information and a list of configurations for the RACH-less switching operation; and
the processor is further configured to:
select, based on the RACH-less switching command, a configuration from the list of the configurations, including a RACH-less UL grant and a UL carrier, and
determine, based on the mapping information, satellite assistance information mapped to the RACH-less UL grant, and
determine a UL timing advance (UL TA) and a frequency shift based on the satellite assistance information, and
compensate the UL TA and the frequency shift to perform the initial UL transmission for the RACH-less switching operation, and
the transceiver is further configured to perform the initial UL transmission based on the RACH-less UL grant corresponding to the UL carrier.

3. The UE of claim 2, wherein:
the satellite assistance information includes at least one of satellite ephemeris or TA information;
the RACH-less switching operation includes a handover operation, a satellite switching operation, or a cell switching operation; and
the configuration further includes beam information comprising a transmission configuration indicator (TCI) state and a synchronization signal block (SSB) index.

4. The UE of claim 1, wherein:
the transceiver is further configured to receive mapping information between a list of satellite assistance information and a list of RACH resources including at least one of a set of synchronization signal block (SSB) indexes or a set of preamble indexes for a physical random access channel (PRACH) preamble;
the processor is further configured to:
select a RACH resource based on the list of RACH resources,
determine, based on the mapping information, the satellite assistance information mapped to the RACH resource,
determine, based on the satellite assistance information, the UL timing advance (UL TA) and a frequency shift, and
compensate the UL TA and the frequency shift to transmit the PRACH preamble; and
the transceiver is further configured to transmit the PRACH preamble based on the RACH resource.

5. The UE of claim 1, wherein:
the transceiver is further configured to receive, from the base station, an indication associated with the RACH-less UL grant for the RACH-less switching operation based on a type of the UL carrier;
the type of the UL carrier comprises a normal UL carrier or a supplemental UL carrier; and
the type of the UL carrier is indicated via downlink control information (DCI) or included in configuration information for the RACH-less switching operation.

6. The UE of claim 5, wherein the processor is further configured to:
measure a reference signal received power (RSRP) of a downlink (DL) pathloss reference signal; and
select the supplemental UL carrier when a measurement result of the RSRP of the DL pathloss reference signal is less than an RSRP threshold or select the normal UL carrier when the measurement result of the RSRP of the DL pathloss reference signal is greater than the RSRP threshold, and
wherein the indication comprises the RSRP threshold for configuring the RACH-less UL grant.

7. The UE of claim 6, wherein the transceiver is further configured to receive the RACH-less UL grant configured on the normal UL carrier or the supplemental UL carrier.

8. The UE of claim 1, wherein the processor is further configured to release the RACH-less UL grant when the RACH-less UL grant for the initial UL transmission of the RACH-less switching operation is included in the RACH-less switching command after the RACH-less switching operation is completed.

9. A method of a user equipment (UE) in a wireless communication system, the method comprising:
receiving, from a base station, a random access channel-less (RACH-less) switching command for a RACH-less switching operation to a target cell;
determining whether a discontinuous reception (DRX) is configured for the target cell;
retaining an active time during the RACH-less switching operation based on a determination that the DRX is configured for the target cell; and
monitoring a physical downlink control channel (PDCCH) to acquire an uplink (UL) grant of an initial UL transmission,
wherein the initial UL transmission for the RACH-less switching operation includes a transmission of a RRCReconfigurationComplete message to a target satellite or the target cell.

10. The method of claim 9, further comprising:
receiving mapping information between a list of satellite assistance information and a list of configurations for the RACH-less switching operation;
selecting, based on the RACH-less switching command, a configuration from the list of the configurations, including a RACH-less UL grant and a UL carrier;
determining, based on the mapping information, satellite assistance information mapped to the RACH-less UL grant;
determining a UL timing advance (UL TA) and a frequency shift based on the satellite assistance information;
compensating the UL TA and the frequency shift to perform the initial UL transmission for the RACH-less switching operation; and
performing the initial UL transmission based on the RACH-less UL grant corresponding to the UL carrier.

11. The method of claim 10, wherein:
the satellite assistance information includes at least one of satellite ephemeris or TA information;
the RACH-less switching operation includes a handover operation, a satellite switching operation, or a cell switching operation; and
the configuration further includes beam information comprising a transmission configuration indicator (TCI) state and a synchronization signal block (SSB) index.

12. The method of claim 9, further comprising:
receiving mapping information between a list of satellite assistance information and a list of RACH resources including at least one of a set of synchronization signal block (SSB) indexes or a set of preamble indexes for a physical random access channel (PRACH) preamble;
selecting a RACH resource based on the list of RACH resources;
determining, based on the mapping information, the satellite assistance information mapped to the RACH resource;
determining, based on the satellite assistance information, the UL timing advance (UL TA) and a frequency shift; and
compensating the UL TA and the frequency shift to transmit the PRACH preamble; and
transmitting the PRACH preamble based on the RACH resource.

13. The method of claim 9, further comprising receive, from the base station, an indication associated with the RACH-less UL grant for the RACH-less switching operation based on a type of the UL carrier,
wherein the type of the UL carrier comprises a normal UL carrier or a supplemental UL carrier, and wherein the type of the UL carrier is indicated via downlink control information (DCI) or included in configuration information for the RACH-less switching operation.

14. The method of claim 13, further comprising:
measuring a reference signal received power (RSRP) of a downlink (DL) pathloss reference signal; and
selecting the supplemental UL carrier when a measurement result of the RSRP of the DL pathloss reference signal is less than an RSRP threshold or select the normal UL carrier when the measurement result of the RSRP of the DL pathloss reference signal is greater than the RSRP threshold,
wherein the indication comprises the RSRP threshold for configuring the RACH-less UL grant.

15. The method of claim 14, further comprising receiving the RACH-less UL grant configured on the normal UL carrier or the supplemental UL carrier.

16. The method of claim 9, further comprising releasing the RACH-less UL grant when the RACH-less UL grant for the initial UL transmission of the RACH-less switching operation is included in the RACH-less switching command after the RACH-less switching operation is completed.

17. A base station (BS) in a wireless communication system, the BS comprising:
a processor configured to:
generate a random access channel-less (RACH-less) switching command, and
generate a discontinuous reception (DRX) configuration; and
a transceiver operably coupled to the processor, the transceiver configured to:
transmit, to a user equipment (UE), the RACH-less switching command for a RACH-less switching operation to a target cell,
transmit, to the UE, the DRX configuration, and
transmit, to the UE, a physical downlink control channel (PDCCH),
wherein:
whether the DRX is configured for the target cell is determined,
an active time is retained during the RACH-less switching operation based on a determination that the DRX is configured for the target cell,
the PDCCH is monitored to acquire an uplink (UL) grant of an initial UL transmission, and
the initial UL transmission for the RACH-less switching operation includes a transmission of a RRCReconfigurationComplete message to a target satellite or the target cell.

18. The BS of claim 17, wherein:
the transceiver is further configured to transmit mapping information between a list of satellite assistance information and a list of configurations for the RACH-less switching operation;
the processor is further configured to perform the initial UL transmission based on the RACH-less UL grant corresponding to the UL carrier;
the satellite assistance information includes at least one of satellite ephemeris or TA information;
the RACH-less switching operation includes a handover operation, a satellite switching operation, or a cell switching operation; and
the configuration further includes beam information comprising a transmission configuration indicator (TCI) state and a synchronization signal block (SSB) index.

19. The BS of claim 17, wherein the transceiver is further configured to:
transmit mapping information between a list of satellite assistance information and a list of RACH resources including at least one of a set of synchronization signal block (SSB) indexes or a set of preamble indexes for a physical random access channel (PRACH) preamble; and
transmit the PRACH preamble based on the RACH resource.

20. The BS of claim 17, wherein:
the transceiver is further configured to transmit, to the UE, an indication associated with the RACH-less UL grant for the RACH-less switching operation based on a type of the UL carrier;
the type of the UL carrier comprises a normal UL carrier or a supplemental UL carrier;
the type of the UL carrier is indicated via downlink control information (DCI) or included in configuration information for the RACH-less switching operation; and
the transceiver is further configured to transmit the RACH-less UL grant configured on the normal UL carrier or the supplemental UL carrier.
